(19) United States
(12) Patent Application Publication
(10) Pub. No.: US 2025/0167504 A1
(43) Pub. Date: May 22, 2025

(54) OPTICS PROTECTIVE EJECTION COOLER

(71) Applicant: AGENCY FOR DEFENSE DEVELOPMENT, Daejeon (KR)

(72) Inventors: Sang-Wook JIN, Daejeon (KR); Ho-Jin CHOI, Daejeon (KR); Ju-Hyun BAE, Daejeon (KR); Dong-Chang PARK, Daejeon (KR)

(21) Appl. No.: 18/949,293

(22) Filed: Nov. 15, 2024

(30) Foreign Application Priority Data
Nov. 20, 2023 (KR) 10-2023-0161227

(51) Int. Cl. H01S 3/04

(52) U.S. Cl. CPC H01S 3/0404; H01S 3/0401

(57) ABSTRACT

An ejection cooler for protecting optical equipment that installs an optical window that divides the inside of the cooler body into two areas so that the surface of the cooler body in which the light source generator for irradiating a light source to observe a specific part of a flow area where a flame exists is installed can be cooled by film cooling, and that forms the slit-shaped ejection port vertically so that the light passes through the optical window and is irradiated through the cooler body. Therefore, the amount of cooling air can increase and the ejection pressure can increase to protect the light source generator from high temperatures, and when the light source passes through the ejection port, the beam can be spread so that an optical path is formed in the form of a thin surface that gradually widens in the vertical direction.

### CROSS REFERENCE TO RELATED APPLICATION

The present application claims priority to Korean Patent Application No. 10-2023-0161227, filed Nov. 20, 2023, the entire contents of which is incorporated herein for all purposes by this reference.

### BACKGROUND OF THE INVENTION

### 1. Field of the Invention

The present invention relates to an ejection cooler for protecting optical equipment, and more particularly, to an ejection cooler for protecting optical equipment which can protect a light source generator for irradiating a high-energy light source such as a laser to observe a specific portion of a flow area where a flame exists in a state where the flame is exposed.

### 2. Description of Related Art

There is a spray-type cooling method as a measure to protect structures exposed to high-temperature flames.

A typical example is to cool the turbine of a gas turbine engine by drilling fine holes in the blade surface and flowing cooling gas from the inside to the outside to prevent the flame from directly contacting the surface and protecting the structure.

This conventional technology, although slightly different in shape as shown in FIGS. 1 to 4, uses a method of flowing cooling gas through fine holes on the surface and forming a film through this to cool the structure.

However, this conventional method was not a problem when the flow rate of the exposed gas was small, but had the problem that it was difficult to protect the surface when the flow rate was high and the amount of heat transfer was large.

### DOCUMENTS OF RELATED ART

(Patent Document 0001) US Registered U.S. Pat. No. 11,592,401 (2023 Feb. 28)

### SUMMARY OF THE INVENTION

An object of the present invention is to provide an ejection cooler for protecting optical equipment capable of cooling the surface of a cooler body by film cooling to protect a light source generator.

In order to achieve the above object, an ejection cooler for protecting optical equipment according to an embodiment of the present invention comprises a cooler body in which an ejection port is formed; an upper cooling gas inlet pipe which is installed on an upper portion of the cooler body to inject cooling gas into an inside of the cooler body; a lower cooling gas inlet pipe which is installed on a lower portion of the cooler body to inject the cooling gas into the inside of the cooler body; an optical window which is installed to divide the inside of the cooler body into two areas and transmitting a light source; and a light source generator which is installed on a rear side of the inside of the cooler body to generate a light source so that the light passes through the optical window and is irradiated to an outside through the ejection port.

As another embodiment, the cooler body of the present invention includes a rear part that is opened on a front side; and a front part that extends integrally from a front opening of the rear part toward a front and slanting toward a center to form the ejection port.

As another embodiment, the ejection port 12 formed vertically in a shape of a slit in a center of the front part.

As another embodiment, an ejection angle of the ejection port of the present invention is formed to become wider as it goes from an inlet area toward an outlet area.

As another embodiment, the ejection port of the present invention is formed by rounding an inner side of the front part and an outer edge of the front part.

As another embodiment, in the present invention, an upper cover is coupled to the upper portion of the cooler body to simultaneously cover the front part and the rear part to correspond to shapes of the front part and the rear part, and a lower cover is coupled to the lower portion of the cooler body to simultaneously cover the front part and the rear part to correspond to the shapes of the front part and the rear part.

As another embodiment, the upper cooling gas inlet pipe of the present invention is installed vertically toward an upper center of the front part with respect to the upper cover.

As another embodiment, the lower cooling gas inlet pipe of the present invention is installed vertically toward a lower center of the front part with respect to the lower cover.

As another embodiment, in the present invention, on a lower surface of the upper cover, an upper cooling gas reduction part is formed that is expanded to a greater extent than a lower inner diameter of the upper cooling gas inlet pipe, on the upper surface of the lower cover, a lower cooling gas reduction part is formed that is expanded to a greater extent than an upper inner diameter of the lower cooling gas inlet pipe.

As another embodiment, in the present invention, the upper cooling gas reduction part and the lower cooling gas reduction part are formed in a chamfered or rounded shape so as to gradually widen toward an inside of the cooler body.

As another embodiment, in the present invention, the upper cooling gas inlet pipe and the lower cooling gas inlet pipe are installed facing each other vertically.

As another embodiment, the optical window of the present invention is supported by a support frame to divide areas of the front part and the rear part with respect to an inside of the cooler body.

As another embodiment, the support frame of the present invention is formed as a left and right pair, and between the left and right pair, and forms a light path so that the light generated from the light source generator passes through a center of the optical window.

As another embodiment, the light source generator is installed at a middle height of the rear part with respect to an inside of the cooler body.

In this way, the present invention is an ejection cooler for protecting optical equipment that installs the optical window that divides the inside of the cooler body into two areas so that the surface of the cooler body in which the light source generator for irradiating a high-energy light source such as a laser to observe a specific part of a flow area where a flame exists in a state where the flame is exposed is installed can be cooled by film cooling, and that forms the slit-shaped ejection port vertically so that the light generated from the light source generator passes through the optical window and is irradiated to the outside through the cooler body. Therefore, there are effects in that depending on the test environment, when the heat flux is large and the flow rate is high, the amount of cooling air can be increased and the ejection pressure can be increased to protect the light source generator 50 from coming into contact with high temperatures, and that when the light source passes through the ejection port 12, the beam can be spread so that an optical path is formed in the form of a thin surface that gradually widens in the vertical direction.

### BRIEF DESCRIPTION OF THE DRAWINGS

FIG. 1 is an exemplary diagram of a blade for a gas turbine according to a conventional embodiment.

FIG. 2 is an exemplary diagram of a multimeter and diffusion transpiration cooling airfoil according to another conventional embodiment.

FIG. 3 and FIG. 4 are exemplary diagrams of a transpiration cooling system according to another conventional embodiment.

FIG. 5 is an exemplary drawing of an external appearance of an ejection cooler for protecting optical equipment according to the present invention.

FIG. 6 is an exemplary diagram of an internal appearance of an ejection cooler for protecting optical equipment according to the present invention.

FIG. 7A and FIG. 7B are exemplary diagrams illustrating partial cutaway of an ejection cooler for protecting optical equipment according to the present invention.

FIG. 8 is an exemplary diagram illustrating a side view of an ejection cooler for protecting optical equipment according to the present invention.

FIG. 9 is an exemplary diagram illustrating a cross-section along line B-B of FIG. 8.

FIG. 10 is an exemplary diagram illustrating an optical path of an ejection cooler for protecting optical equipment according to the present invention.

FIG. 11 is an exemplary diagram illustrating a cooling gas path of an ejection cooler for protecting optical equipment according to the present invention.

FIG. 12 is an exemplary diagram illustrating a cooling gas and high-temperature gas paths of an ejection cooler for protecting optical equipment of the present invention.

FIG. 13 is an exemplary diagram illustrating a shape of an ejection port of an ejection cooler for protecting optical equipment of the present invention.

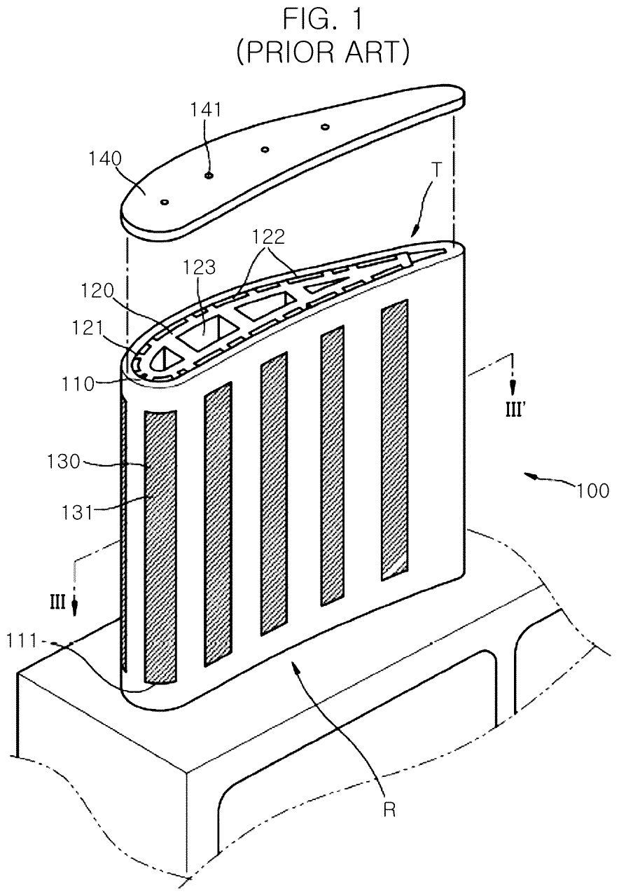

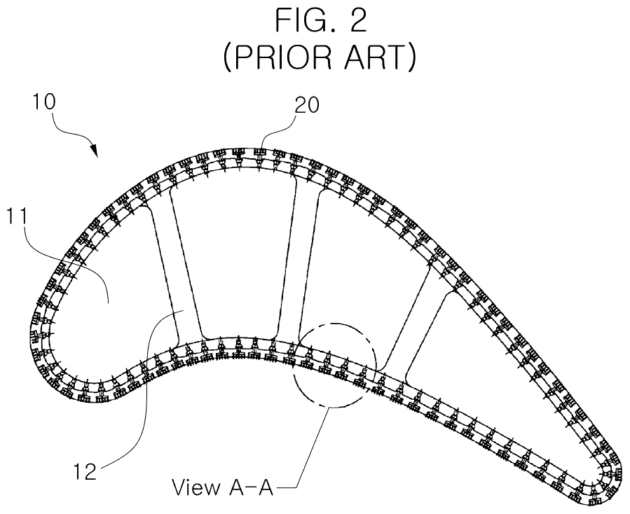

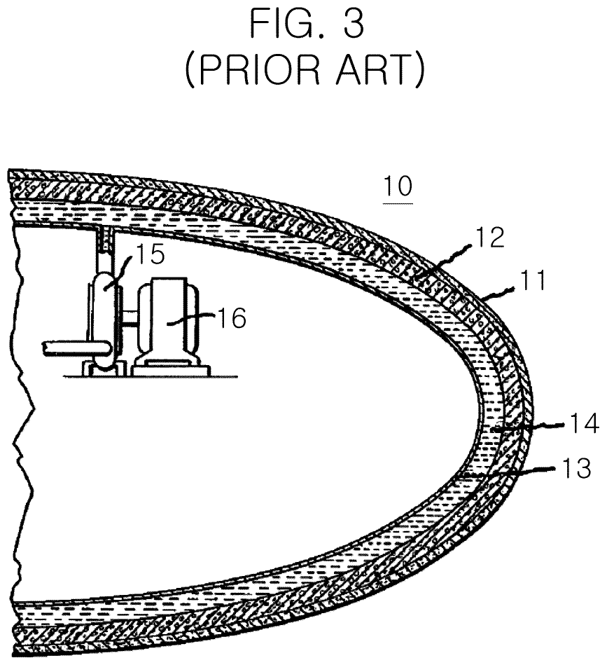

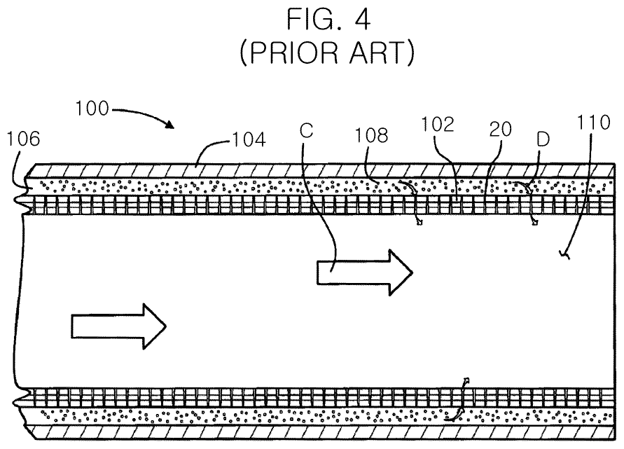

### DETAILED DESCRIPTION OF THE INVENTION

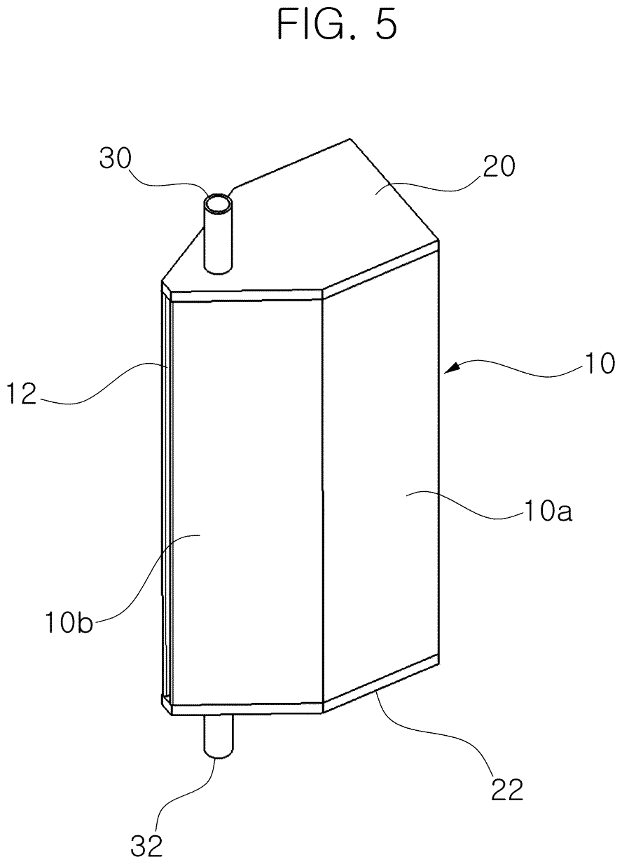

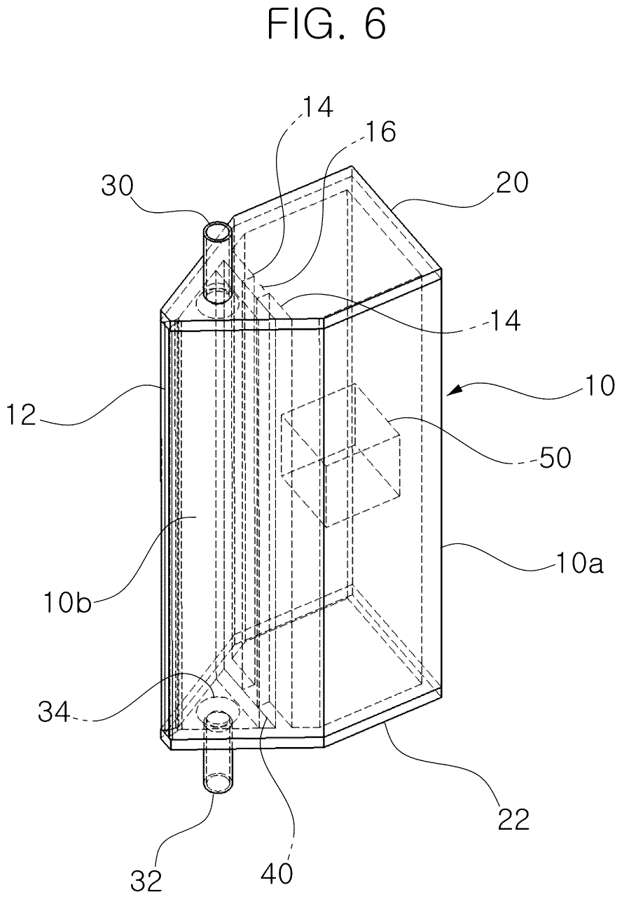

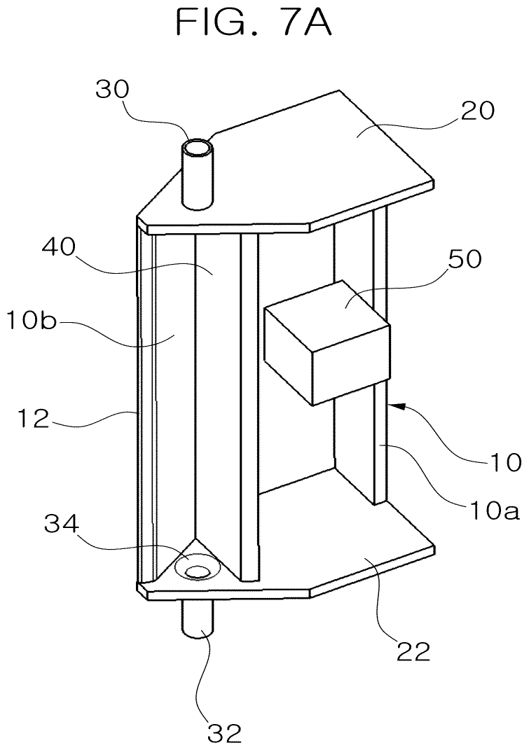

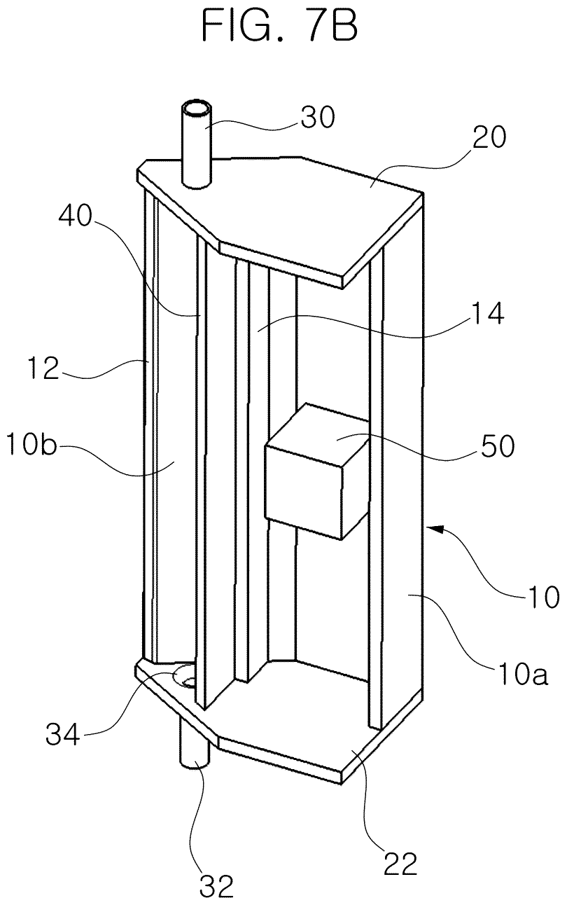

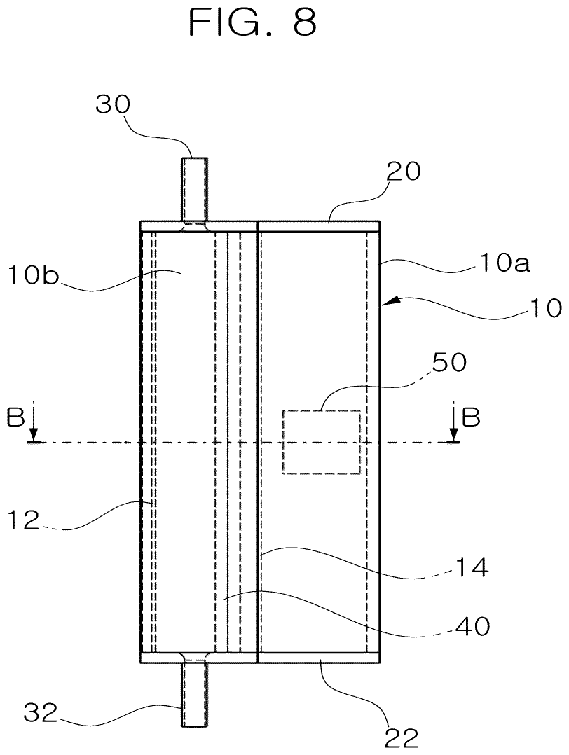

Hereinafter, in order to fully understand the present invention, a preferred embodiment of the present invention will be described with reference to the accompanying drawings, FIGS. 5 to 13. The embodiment of the present invention may be modified in various forms, and the scope of the present invention should not be construed as being limited to the embodiments described in detail below. It should be noted that in each drawing, the same components are sometimes illustrated with the same reference numerals. Detailed descriptions of known functions and components that may unnecessarily obscure the gist of the present invention are omitted.

An ejection cooler for protecting optical equipment according to an embodiment of the present invention includes a cooler body 10, an ejection port 12, a support frame 14, an upper cover 20, a lower cover 22, an upper cooling gas inlet pipe 30, a lower cooling gas inlet pipe 32, an optical window 40, and a light source generator 50.

That is, the cooler body 10 is constituted to include a rear part 10a that is open on the front side, and a front part 10b that extends integrally from the front opening of the rear part 10a toward the front and slanting toward the center to form the ejection port 12.

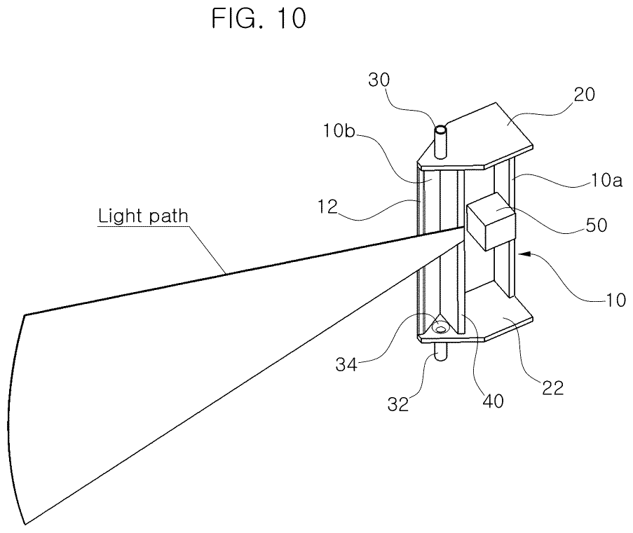

The ejection port 12 is formed vertically in the shape of a slit in the center of the front part 10b, and this slit-shaped ejection port 12 serves to spread beams so that when the light source generated from the light source generator 50 passes through the optical window 40 and is irradiated to the outside through the ejection port 12, a light path that is thin in the shape of a plane and gradually widens in the vertical direction can be formed, as shown in FIG. 10.

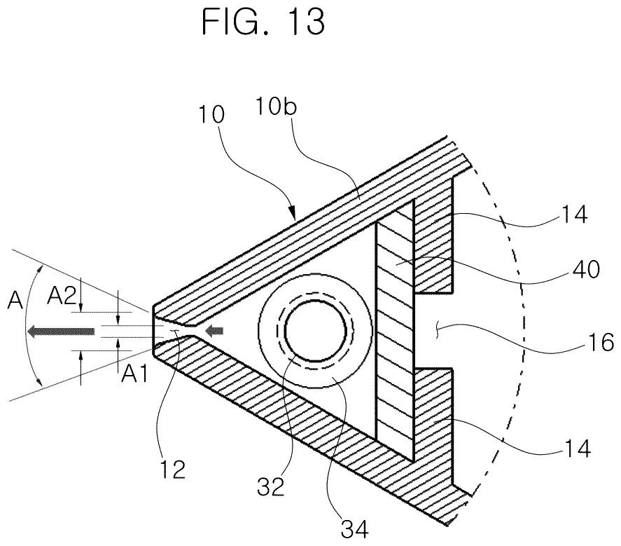

The ejection angle A of the ejection port 12 is formed to become wider as it goes from an inlet area A1 facing the inside of the cooler body 10 toward an outlet area A2 facing the outside of the cooler body 10, as shown in FIG. 13. This ejection angle A serves to cool the temperature of the gas while increasing the speed of the gas being ejected.

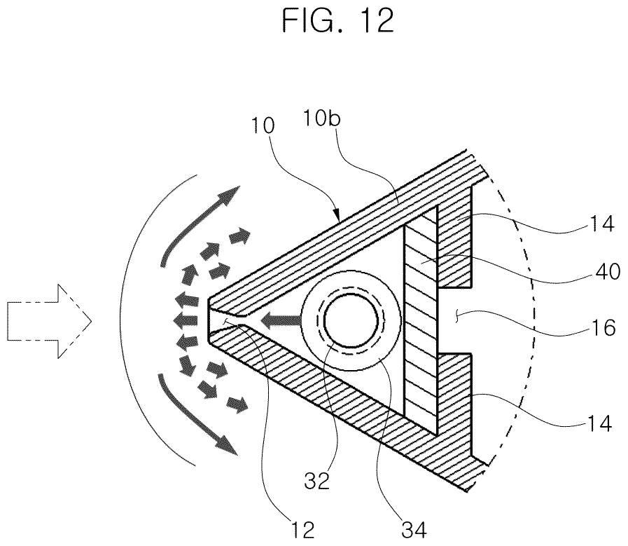

The ejection port 12 is formed by rounding the inner side of the front part 10b and the outer edge of the front part 10b, and the rounding of the edge of the ejection port 12 serves to reduce the loss during acceleration of the gas, and then to allow the gas that has escaped to flow along the outer surface of the front part 10b of the cooler body 10 with less loss, as shown in FIG. 12.

In this case, the ejection port 12 can control the degree of acceleration of the gas and the protection area to be cooled by the gas within the cooler body 10 by setting the ejection angle A.

An upper cover 20 is coupled to the upper portion of the cooler body 10 to simultaneously cover the front part 10b and rear part 10a to correspond to the shapes of the front part 10b and rear part 10a. A lower cover 22 is coupled to the lower portion of the cooler body 10 to simultaneously cover the front part 10b and rear part 10a to correspond to the shapes of the front part 10b and rear part 10a.

On the lower surface of the upper cover 20, an upper cooling gas reduction part 24a is formed that is expanded to a greater extent than the lower inner diameter of the upper cooling gas inlet pipe 30.

On the upper surface of the lower cover 22, a lower cooling gas reduction part 24b is formed that is expanded to a greater extent than the upper inner diameter of the lower cooling gas inlet pipe 32.

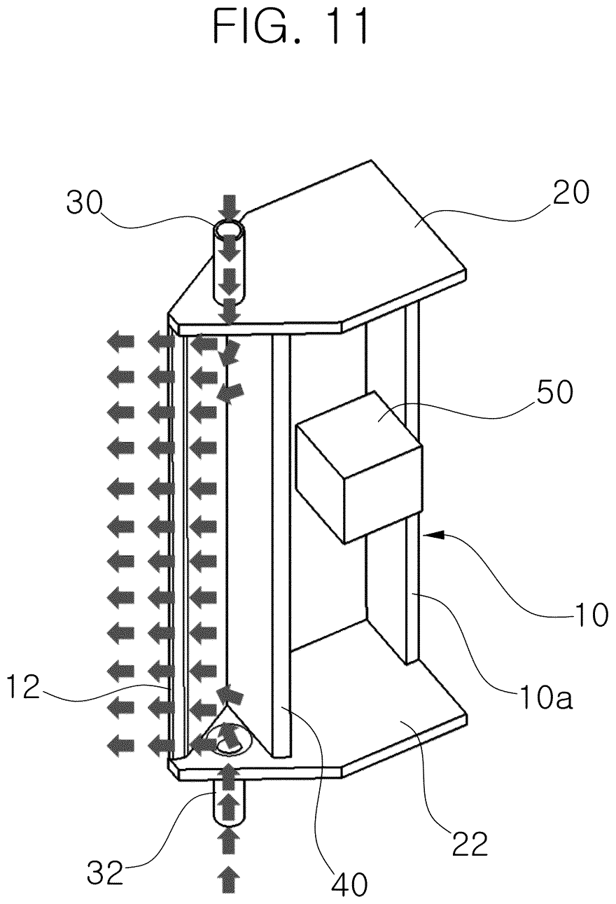

In this case, the upper cooling gas reduction part 24a and lower cooling gas reduction part 24b are formed in a chamfered or rounded shape so as to gradually widen toward the inside of the cooler body 10. This chamfered or rounded shape serves to reduce the flow velocity and make the flow uniform in the form of a diffuser in order to reduce the deceleration and turbulence of the cooling gas flowing through the upper cooling gas inlet pipe 30 and lower cooling gas inlet pipe 32, respectively, as shown in FIG. 11.

The upper cooling gas inlet pipe 30 is installed vertically toward the upper center of the front part 10b through the upper cover 20 on the upper portion of the cooler body 10 and serves to inject cooling gas into the inside of the cooler body 10.

The lower cooling gas inlet pipe 32 is installed vertically toward the lower center of the front part 10b through the lower cover 22 on the lower portion of the cooler body 10 and serves to inject cooling gas into the inside of the cooler body 10.

In this case, it is preferable that the upper cooling gas inlet pipe 30 and lower cooling gas inlet pipe 32 are installed facing each other vertically.

The above optical window 40 is installed between the front part 10b and the rear part 10a via the support frame 14 to divide the inside of the cooler body 10 into two areas, and transmits the light source generated from the light source generator 50, prevents the loss of cooling gas flowing into the front part 10b of the cooler body 10 from flowing toward the light source generator 50 installed in the rear part 10a, or prevents the high-temperature fluid generated from the external structure of the cooler body 10 from directly contacting the light source generator 50, thereby protecting the light source generator 50 from being damaged by high temperature.

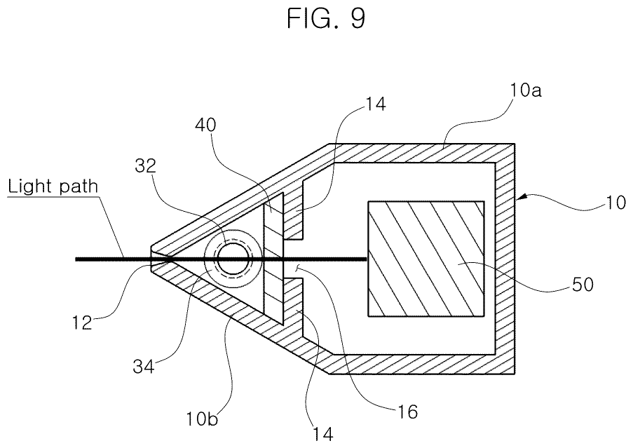

In this case, the support frame 14 is formed as a left and right pair, and between the left and right pair, and serves to form, as shown in FIG. 9, a light path 16 so that the light generated from the light source generator 50 passes through the center of the optical window 40 and is irradiated to the outside through the ejection port 12.

The light source generator 50 is installed at the middle height of the rear part 10a with respect to the inside of the cooler body 10 and plays a role in generating a light source.

In this way, the present invention is an ejection cooler for protecting optical equipment that installs the optical window 40 that divides the inside of the cooler body 10 into two areas so that the surface of the cooler body 10 in which the light source generator 50 for irradiating a high-energy light source such as a laser to observe a specific part of a flow area where a flame exists in a state where the flame is exposed is installed can be cooled by film cooling, and that forms the slit-shaped ejection port 12 vertically so that the light generated from the light source generator 50 passes through the optical window 40 and is irradiated to the outside through the cooler body 10. Therefore, there are advantages in that depending on the test environment, when the heat flux is large and the flow rate is high, the amount of cooling air can be increased and the ejection pressure can be increased to protect the light source generator 50 from coming into contact with high temperatures, and that when the light source passes through the ejection port 12, the beam can be spread so that an optical path is formed in the form of a thin surface that gradually widens in the vertical direction.

Meanwhile, the present invention is not limited to the above-described embodiments, but can be implemented by modifying and changing the same within a scope that does not depart from the gist of the present invention, and the technical ideas to which such modifications and changes are applied should also be considered to fall within the scope of the following claims.

### DESCRIPTION OF REFERENCE NUMERALS

10: cooler body
10a: rear part
10b: front part
12: ejection port
14: support frame
16: light path
20: upper cover
22: lower cover 22
24a: upper cooling gas reduction par
24b: lower cooling gas reduction par
30: upper cooling gas inlet pipe
32: lower cooling gas inlet pipe
40: optical window
50: light source generator

What is claimed is:

1. An ejection cooler for protecting optical equipment, comprising:
a cooler body 10 in which an ejection port 12 is formed;
an upper cooling gas inlet pipe 30 which is installed on an upper portion of the cooler body 10 to inject cooling gas into an inside of the cooler body 10;
a lower cooling gas inlet pipe 32 which is installed on a lower portion of the cooler body 10 to inject the cooling gas into the inside of the cooler body 10;
an optical window 40 which is installed to divide the inside of the cooler body 10 into two areas and transmitting a light source; and
a light source generator 50 which is installed on a rear side of the inside of the cooler body 10 to generate a light source so that the light passes through the optical window 40 and is irradiated to an outside through the ejection port 12.

2. The ejection cooler of claim 1, wherein the cooler body 10 includes:
a rear part 10a that is opened on a front side; and
a front part 10b that extends integrally from a front opening of the rear part 10a toward a front and slanting toward a center to form the ejection port 12.

3. The ejection cooler of claim 2, wherein the ejection port 12 is formed vertically in a shape of a slit in a front center of the front part 10b.

4. The ejection cooler of claim 2, wherein an ejection angle A of the ejection port 12 is formed to become wider as it goes from an inlet area A1 toward an outlet area A2.

5. The ejection cooler of claim 2, wherein the ejection port 12 is formed by rounding an inner side of the front part 10b and an outer edge of the front part 10b.

6. The ejection cooler of claim 2, wherein an upper cover 20 is coupled to the upper portion of the cooler body 10 to simultaneously cover the front part 10b and the rear part 10a to correspond to shapes of the front part 10b and the rear part 10a, and a lower cover 22 is coupled to the lower portion of the cooler body 10 to simultaneously cover the front part 10b and the rear part 10a to correspond to the shapes of the front part 10b and the rear part 10a.

7. The ejection cooler of claim 6, wherein the upper cooling gas inlet pipe 30 is installed vertically toward an upper center of the front part 10b with respect to the upper cover 20.

8. The ejection cooler of claim 6, wherein the lower cooling gas inlet pipe 32 is installed vertically toward a lower center of the front part 10b with respect to the lower cover 22.

9. The ejection cooler of claim 6, wherein on a lower surface of the upper cover 20, an upper cooling gas reduction part 24a is formed that is expanded to a greater extent than a lower inner diameter of the upper cooling gas inlet pipe 30, and
on the upper surface of the lower cover 22, a lower cooling gas reduction part 24b is formed that is expanded to a greater extent than an upper inner diameter of the lower cooling gas inlet pipe 32.

10. The ejection cooler of claim 9, wherein the upper cooling gas reduction part 24a and the lower cooling gas reduction part 24b are formed in a chamfered or rounded shape so as to gradually widen toward an inside of the cooler body 10.

11. The ejection cooler of claim 9, wherein the upper cooling gas inlet pipe 30 and the lower cooling gas inlet pipe 32 are installed facing each other vertically.

12. The ejection cooler of claim 1, wherein the optical window 40 is supported by a support frame 14 to divide areas of the front part 10b and the rear part 10a with respect to an inside of the cooler body 10.

13. The ejection cooler of claim 12, wherein the support frame 14 is formed as a left and right pair, and between the left and right pair, and forms a light path 16 so that the light generated from the light source generator 50 passes through a center of the optical window 40.

14. The ejection cooler of claim 6, wherein the light source generator 50 is installed at a middle height of the rear part 10a with respect to an inside of the cooler body 10.
